(19) United States
(12) Patent Application Publication
(10) Pub. No.: US 2025/0089134 A1
(43) Pub. Date: Mar. 13, 2025

(54) LIGHTING APPARATUS

(71) Applicant: LEEDARSON LIGHTING CO.,LTD., Zhangzhou (CN)

(72) Inventors: Junjie Lin, Zhangzhou (CN); Jiansheng Zhang, Zhangzhou (CN); Tiansong Lan, Zhangzhou (CN); Yongjun Bao, Zhangzhou (CN); Haiyan Chen, Zhangzhou (CN)

(21) Appl. No.: 18/412,460

(22) Filed: Jan. 12, 2024

(30) Foreign Application Priority Data
Sep. 7, 2023 (CN) 202311152376.X

(51) Int. Cl. H05B 45/20; H05B 45/10; H05B 45/37

(52) U.S. Cl. CPC H05B 45/20; H05B 45/10; H05B 45/37

(57) ABSTRACT

A lighting apparatus includes one or more first type LED modules, one or more second type LED modules and a driver circuit. The first type LED modules emits a first light of a first color temperature. The second type LED modules emits a second light of a second color temperature. The first color temperature is different from the second color temperature. The driver circuit provides a first working mode and a second working mode. In the first working mode, the second type LED modules are disabled so that only the first type LED modules are turned on to emit a first output light of the first color temperature. In the second working mode, the first type LED modules and the second type LED modules are both turned on to generate a second output light of a third color temperature.

### FIELD

The present invention is related to a lighting apparatus, and more particularly related to a lighting apparatus with a flexible setting.

### BACKGROUND

Downlight devices are commonly recessed into ceilings or walls and are known for their ability to provide ambient lighting. They offer a clean and modern appearance, making them suitable for various settings, including homes and offices. Downlights are designed to distribute light evenly, creating a soft and pleasing illumination that enhances the overall atmosphere.

Spotlight devices, on the other hand, are directional light fixtures that focus a concentrated beam of light on a specific area or object. They are versatile and find applications in both residential and commercial spaces. Spotlights are often used to highlight artwork, architectural features, or products in retail displays. In the world of theatrical and stage lighting, spotlights are indispensable for directing attention to performers or props.

Combining different types of light devices can lead to creative and customizable lighting solutions. For instance, in a museum, a combination of downlights and spotlights can be employed. Downlights serve the purpose of providing general ambient lighting, while strategically placed spotlights accentuate individual exhibits, achieving a balance between overall illumination and the highlighting of specific objects.

Apart from downlights and spotlights, task lighting devices play a crucial role in various environments, such as workspaces. Desk lamps and under-cabinet lights are examples of task lighting fixtures designed to provide focused illumination for specific tasks like reading, writing, or cooking. Task lighting contributes to increased productivity and minimizes glare, ensuring that individuals can perform their tasks comfortably.

When it comes to outdoor environments, different light devices cater to diverse needs. Path lights guide people along walkways and gardens, enhancing safety and aesthetics in outdoor spaces. Floodlights, on the other hand, are used to illuminate large outdoor areas like stadiums or parking lots, providing the necessary visibility and security during nighttime events or activities.

Light Emitting Diodes (LEDs) have ushered in a significant transformation in the world of lighting, revolutionizing past light devices in profound ways. Unlike traditional incandescent or fluorescent bulbs, LEDs are highly energy-efficient and have a much longer lifespan. This has led to reduced energy consumption and lower maintenance costs, making them an attractive option for both residential and commercial applications.

One of the most notable impacts of LEDs is their versatility. They can be incorporated into a wide range of light devices, from standard bulbs to specialized fixtures like downlights, spotlights, and even architectural lighting systems. LEDs are incredibly compact, allowing for sleek and innovative designs that were not possible with older technologies. This adaptability has made LEDs a go-to choice for interior and exterior lighting solutions.

Furthermore, LEDs offer precise control over color temperature and brightness. This level of control is especially valuable in settings where specific lighting effects are desired, such as theaters, art galleries, and architectural lighting. LEDs can be tuned to produce warm or cool lighting, and their dimmability enhances ambiance and energy conservation.

As LEDs have continued to evolve, they have become an integral part of smart lighting systems. These systems allow users to remotely control and customize their lighting to suit different moods and activities. Additionally, LEDs are compatible with automation and sensor technologies, enabling responsive lighting solutions that adjust to occupancy, daylight levels, and user preferences.

The energy savings and environmental benefits associated with LEDs have led to widespread adoption in streetlights, traffic signals, and industrial lighting. Their durability and reliability make them well-suited for outdoor applications, where they can withstand harsh weather conditions and provide consistent illumination.

In summary, LED technology has not only revolutionized traditional lighting devices but has also expanded its reach to a wide array of light fixtures, providing energy efficiency, longevity, and versatility. This innovation has improved the quality of illumination in various environments while offering sustainable and cost-effective lighting solutions for the future.

Controlling LED light devices is notably easier when compared to past light devices due to the advanced technology and flexibility that LEDs offer. Unlike traditional incandescent or fluorescent bulbs, LEDs are inherently more adaptable to complex circuitry, allowing for precise control and customization of lighting scenarios. This ease of control has paved the way for innovative lighting solutions across various applications.

Complex circuits can be implemented to manipulate LED light devices, granting users greater command over their lighting systems. For instance, dimmer switches can be integrated to adjust the brightness of LED lights effortlessly. Additionally, color-changing LEDs can be controlled to produce a vast spectrum of hues, perfect for creating dynamic lighting effects in entertainment venues, architectural lighting, or even in residential settings. Moreover, LEDs can be synchronized with sensors and timers for automated lighting, enhancing energy efficiency and convenience.

However, it's worth noting that while complex circuits offer substantial benefits in terms of control, they can sometimes bring unintended side effects. One of the primary concerns is cost. Implementing intricate control systems, especially for large-scale installations, can be expensive due to the need for specialized hardware and software. The initial investment in complex LED control systems may deter some users.

Another potential side effect of complexity is stability. As control systems become more intricate, there is a greater risk of technical issues or malfunctions. This can lead to disruptions in lighting operations, which can be particularly problematic in critical environments such as healthcare facilities or industrial settings. Maintenance and troubleshooting can become more challenging and costly as well.

Despite these challenges, the advantages of enhanced control over LED light devices usually outweigh the drawbacks. With advancements in technology and ongoing research, efforts are being made to address issues related to cost and stability. As LED lighting continues to evolve, it is expected that control systems will become more user-friendly and reliable, making it easier for individuals and businesses to harness the full potential of this energy-efficient lighting technology.

In conclusion, the realm of LED lighting technology offers substantial opportunities for innovative designs tailored to diverse requirements. The ease of control provided by LEDs, although sometimes accompanied by complexities, presents a fertile ground for creative solutions. Striking a delicate balance between advanced features and cost-effective, stable systems remains a challenge yet to be fully realized. Given the widespread use of light devices in numerous aspects of human life, even incremental improvements hold the potential to make significant contributions, enhancing the quality of illumination and energy efficiency for homes, businesses, and public spaces. The quest for novel designs in LED lighting continues to shape the future of lighting technology, promising more sustainable, adaptable, and user-friendly solutions that benefit society as a whole.

### SUMMARY

In some embodiments, a lighting apparatus includes one or more first type LED modules, one or more second type LED modules and a driver circuit.

The first type LED modules emits a first light of a first color temperature.

The second type LED modules emits a second light of a second color temperature.

The first color temperature is different from the second color temperature.

The driver circuit converts an external power to generate multiple driving currents to the first type of LED modules and the second type of LED modules.

The driver circuit provides a first working mode and a second working mode.

In the first working mode, the second type LED modules are disabled so that only the first type LED modules are turned on to emit a first output light of the first color temperature.

In the second working mode, the first type LED modules and the second type LED modules are both turned on to generate a second output light of a third color temperature.

In some embodiments, an intensity offset between the first output light of each first type LED module and the second output light of each second type LED module is less than 10% of a first light intensity of the first output light of the first type LED module.

In some embodiments, a first total driving current supplied to the first type LED modules in the first working mode is larger a second total driving current supplied to the second type LED modules in the second working mode.

In some embodiments, the lighting apparatus may also include a manual switch coupled to the driver circuit for a user to select the first working mode or the second working mode.

In some embodiments, the lighting apparatus may also include a light housing.

The manual switch is disposed on an external surface of the light housing, and the first type LED modules and the second type LED modules are disposed inside the light housing.

In some embodiments, the driver circuit keeps either the first working mode or the second working mode unless the user operates the manual switch to change a working mode from the first working mode to the second working mode or from the second working mode to the first working mode.

In some embodiments, a label aside the manual switch indicates only the first color temperature and the third color temperature.

The second type LED modules are not turned on if the first type LED modules are not turned on.

In some embodiments, there is a first offset between the first color temperature and the third color temperature.

There is a second offset between the second color temperature and the third color temperature.

The first offset if smaller than the second offset.

In some embodiments, a difference between the first color temperature and the third color temperature is more than 20% of the second offset.

In some embodiments, the difference between the first color temperature and the third color temperature is larger than 50% of the second offset.

In some embodiments, a level switch is coupled to the driver circuit for a user to adjust a first light intensity of the first output light and a second light intensity of the second output light.

In some embodiments, a first variation rate of the driving currents supplied to the first type LED modules is the same as a second variation rate of the driving currents to the second type LED modules.

In some embodiments, the first type LED modules and the second type LED modules are disposed on a single power path for receiving the driving currents.

In some embodiments, the lighting apparatus may also include a light source plate.

The first type of LED modules and the second type of LED modules are arranged on multiple concentric circles of the light source plate.

In some embodiments, a first concentric circle is used for disposed the first type LED modules.

A second concentric circle is used for disposing the second type LED modules.

In a circular sector covering a portion of the first concentric circle and a portion of the second concentric circle, a first number of the first type LED modules is a multiple of a second number of the second type LED modules.

In some embodiments, a quality of the second type LED modules are determined after the first color temperature and the third color temperature are determined.

In some embodiments, the driver circuit adjusts a current ratio between the driving currents supplied to the first type LED modules and the second type LED modules to change the third color temperature.

In some embodiments, the driver circuit has a night light mode.

In the night light mode, only the second type LED modules are turned on.

In some embodiments, the first type LED modules have a first spreading light angle and the second type LED modules have a second spreading light angle.

The first light spreading angle is different from the second light spreading angle.

In some embodiments, the first type LED modules and the second type LED modules use different types of lenses to achieve different light spreading angles.

### BRIEF DESCRIPTION OF DRAWINGS

FIG. 1 illustrates a flowchart for illustrating how to design a lighting apparatus embodiment.

FIG. 2 illustrates a light source plate mounted with two types of LED modules.

FIG. 3 illustrates a cross-sectional perspective view of another lighting apparatus embodiment.

FIG. 4 illustrates another light source plate example.

FIG. 5 illustrates a lens example.

FIG. 6 illustrates a flowchart for illustrating another design of a lighting apparatus embodiment.

FIG. 7 illustrates three light pattern examples.

FIG. 8 illustrates another light pattern examples.

FIG. 9 illustrates another light pattern examples.

FIG. 10 illustrates light distribution diagrams.

FIG. 11 illustrates a lighting apparatus embodiment.

FIG. 12 illustrates another lighting apparatus embodiment.

FIG. 13 a circular sector example.

FIG. 14 illustrates examples of lenses and spreading angles.

### DETAILED DESCRIPTION

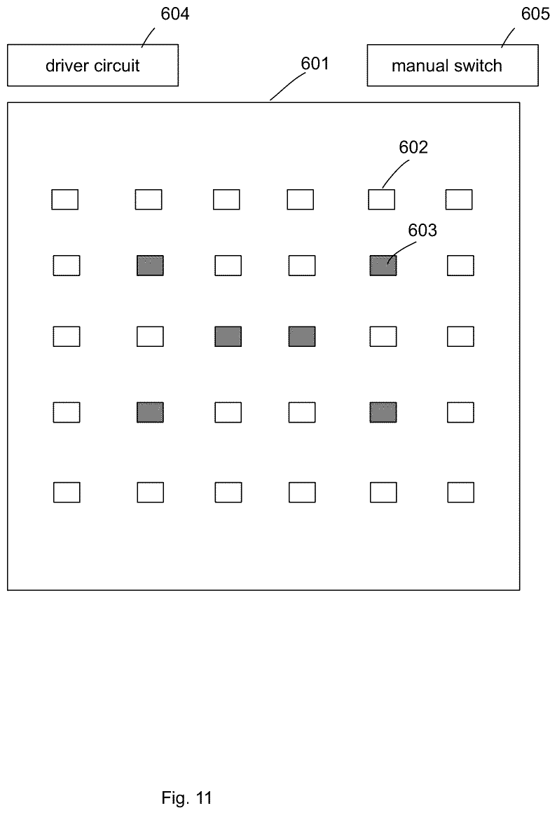

In FIG. 11, a lighting apparatus includes one or more first type LED modules 602, one or more second type LED modules 603 and a driver circuit 601.

The first type LED modules 602 emits a first light of a first color temperature.

The second type LED modules 603 emits a second light of a second color temperature.

The first color temperature is different from the second color temperature.

Standard White LEDs are widely used for general lighting, emitting a neutral white light with a color temperature around 4000-5000 Kelvin (K). These LEDs find applications in residential, commercial, and industrial lighting, offering energy-efficient illumination.

Warm White LEDs, on the other hand, have a lower color temperature, usually around 2700-3500 K, producing a softer and warmer light akin to traditional incandescent bulbs. They are ideal for creating a cozy atmosphere in homes, hotels, and restaurants.

Cool White LEDs possess a higher color temperature, typically between 5500-6500 K, resulting in a crisp and brighter light. They are often preferred for task-oriented spaces like offices, hospitals, and retail environments, where clarity and visibility are paramount.

RGB LEDs are incredibly versatile, capable of emitting light in various colors by adjusting the intensities of the primary colors (Red, Green, Blue). By manipulating these primary colors, a wide range of color temperatures can be achieved, making them suitable for dynamic and customizable lighting effects in entertainment, architectural, and artistic applications.

Tunable White LEDs offer the flexibility to adjust the emitted light's color temperature. These modules incorporate both warm and cool white LEDs, allowing users to simulate natural daylight changes. They prove invaluable in circadian lighting systems, providing the right light at the right time to enhance well-being.

High Color Rendering Index (CRI) LEDs are engineered to accurately represent the colors of illuminated objects. Typically with a color temperature of around 3000-4000 K, these LEDs find a niche in applications where color accuracy is critical, such as art galleries, jewelry stores, and makeup studios.

Creating LED modules that emit lights of different color temperatures involves carefully selecting LED chips with specific phosphor coatings. By altering the phosphor composition, manufacturers can achieve the desired color temperature. Additionally, color-mixing techniques, such as blending warm and cool white LEDs or RGB LEDs, allow dynamic control of color temperatures. Advanced control electronics and dimming systems further empower users to customize color temperatures according to their preferences and specific lighting requirements, making LED lighting exceptionally adaptable and versatile for a wide range of applications.

The driver circuit 604 converts an external power to generate multiple driving currents to the first type of LED modules and the second type of LED modules.

A driver circuit serves a critical role in LED lighting systems by converting external electrical power into the necessary currents to illuminate LED modules. LEDs have specific voltage and current requirements for optimal performance, and the driver circuit ensures these parameters are met.

One of the primary functions of the driver circuit is to regulate the voltage supplied to the LED modules. LEDs are voltage-sensitive, and the driver ensures that the input voltage is matched closely to the LEDs' forward voltage drop. This prevents overdriving or underdriving the LEDs, ensuring they operate within their specified voltage range.

Moreover, driver circuits provide precise control over the current supplied to the LEDs. LEDs are fundamentally current-driven devices, and maintaining a consistent current is crucial for achieving uniform brightness and efficiency across the LED array.

Driver circuits often include protection mechanisms to safeguard the LEDs from voltage spikes, overheating, or excessive current. These protective features contribute to the reliability and longevity of the LEDs, making them suitable for a wide range of applications.

Many driver circuits also offer dimming capabilities, allowing users to adjust the brightness of the LED light device. Dimming can be achieved through various methods, such as pulse-width modulation (PWM), analog dimming, or digital control interfaces, providing not only flexibility but also energy-saving benefits.

The composition of a typical driver circuit comprises several key components. It starts with an input voltage source, which can be either AC (alternating current) or DC (direct current), depending on the LED and driver type. In AC-powered driver circuits, a rectifier is employed to convert AC voltage to DC voltage, ensuring a constant supply for the LEDs. The core of the circuit is a converter or regulator that controls the voltage and current to match the LED's requirements, maintaining a stable operating point on the LED's voltage-current characteristic curve.

Protection components, such as fuses, transient voltage suppressors (TVS), and thermal protection devices, are integrated to safeguard the LEDs from electrical and thermal stresses. In more advanced driver circuits, control interfaces like microcontrollers, digital potentiometers, or dedicated dimming controls are included to provide dimming and control options, enhancing the functionality and adaptability of the LED light device for various lighting applications.

The driver circuit provides a first working mode and a second working mode.

In the first working mode, the second type LED modules are disabled so that only the first type LED modules are turned on to emit a first output light of the first color temperature.

In the second working mode, the first type LED modules and the second type LED modules are both turned on to generate a second output light of a third color temperature.

In some embodiments, an intensity offset between the first output light of each first type LED module and the second output light of each second type LED module is less than 10% of a first light intensity of the first output light of the first type LED module.

In this example, there are two types of LED modules: the first type and the second type. The first type LED module emits a warm white light with a measured first light intensity of 1000 lumens. On the other hand, the second type LED module emits a cool white light with a second light intensity slightly lower at 900 lumens.

In this scenario, there is indeed a light intensity difference between the first output light (from the first type LED module) and the second output light (from the second type LED module). The difference in intensity is 100 lumens (1000 lumens-900 lumens), which represents a 10% offset of the first light intensity of the first type LED module.

However, since the specified condition states that the intensity offset should be “less than 10% of a first light intensity of the first output light of the first type LED module,” this lighting system complies with the requirement. The offset of 100 lumens is indeed less than 10% of the first light intensity of the first type LED module, which is 1000 lumens.

In summary, in this example, two types of LED modules exist with different light intensities, but the intensity offset between their output lights falls within the specified limit of being less than 10% of the first light intensity of the first type LED module, meeting the stated condition.

In some embodiments, a first total driving current supplied to the first type LED modules in the first working mode is larger a second total driving current supplied to the second type LED modules in the second working mode.

For example, there are 100 first type LED modules and there are 20 second type LED modules. In this example, if each first type LED module and each second type LED module receives similar driving currents, the total driving currents to the first type LED modules are about 5 times than the total driving currents to the second type LED modules.

In some embodiments, the lighting apparatus may also include a manual switch 605 coupled to the driver circuit 604 for a user to select the first working mode or the second working mode.

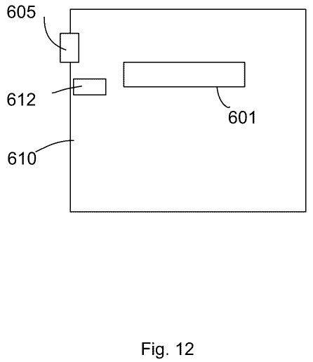

Please also refer to FIG. 12, which shows more component based on the example of FIG. 11. The light source plate 601 that holds the first type LED modules and the second type LED modules is placed in the light housing 610. The manual switch 605 is placed on an exterior surface of the light housing 610.

The manual switch 605 is disposed on an external surface of the light housing 610, and the first type LED modules and the second type LED modules are disposed inside the light housing.

In some embodiments, the driver circuit keeps either the first working mode or the second working mode unless the user operates the manual switch to change a working mode from the first working mode to the second working mode or from the second working mode to the first working mode.

In some embodiments, a label 612 aside the manual switch 605 indicates only the first color temperature and the third color temperature.

The second type LED modules are not turned on if the first type LED modules are not turned on.

In some embodiments, there is a first offset between the first color temperature and the third color temperature. There is a second offset between the second color temperature and the third color temperature. The first offset if smaller than the second offset.

In some embodiments, a difference between the first color temperature and the third color temperature is more than 20% of the second offset.

In a lighting system, there are two types of LED modules: the first type and the second type. Both of these LED modules can emit light of varying color temperatures.

The first type LED modules produce warm white light with a color temperature of 2700 Kelvin (K), while the second type LED modules produce cool white light with a color temperature of 5000 K.

Now, let's consider the third color temperature, which is achieved by mixing light from both the first type LED modules and the second type LED modules. When these two types of LEDs are combined, the resulting mixed light has a color temperature of 3500 K.

According to the statement, we need to evaluate several conditions:

There is a first offset between the first color temperature (2700 K) and the third color temperature (3500 K).

There is a second offset between the second color temperature (5000 K) and the third color temperature (3500 K).

The first offset (2700 K−3500 K) is indeed smaller than the second offset (5000 K−3500 K).

Next, we assess whether the difference between the first color temperature (2700 K) and the third color temperature (3500 K) is more than 20% of the second offset (5000 K−3500 K):

Difference between the first and third color temperatures: 3500 K−2700 K=800 K

20% of the second offset: 20% of (5000 K−3500 K)=300 K

In this example, the difference between the first and third color temperatures (800 K) is indeed more than 20% of the second offset (300 K). Thus, in these embodiments, the conditions specified in the statement are met, as the difference between the color temperatures of the warm white LED modules and the mixed light exceeds the 20% threshold of the second offset.

In some embodiments, the difference between the first color temperature and the third color temperature is larger than 50% of the second offset.

In some embodiments, a level switch is coupled to the driver circuit for a user to adjust a first light intensity of the first output light and a second light intensity of the second output light.

Consider a lighting apparatus in a room equipped with two types of LED modules: warm white and cool white. These LED modules are managed by a driver circuit. Within this setup, there exists a level switch, similar in concept to a wall switch, designed to offer user-adjustable control over the light intensity of the system.

This level switch provides an intuitive means for users to interact with the lighting apparatus by rotating the switch in one direction, users can fine-tune the intensity of the warm white light emitted by the first type LED modules. This adjustment allows them to create the desired brightness level, catering to different lighting needs and ambiance preferences.

Conversely, rotating the switch in the opposite direction empowers users to control the intensity of the cool white light generated by the second type LED modules. This flexibility enables users to increase or decrease the brightness of the cool white light, aligning it with specific lighting requirements.

Moreover, this level switch serves as a master control for the lighting apparatus. As users rotate the switch, it harmoniously adjusts both warm and cool white light intensities simultaneously. This overall intensity control enables users to strike the ideal balance between warm and cool white light, facilitating the creation of tailored lighting atmospheres for various scenarios and preferences.

The level switch, reminiscent of a wall switch, serves as an accessible and user-friendly interface for adjusting the light intensities of warm white and cool white lights in the LED lighting system. Its dual-functionality enhances convenience and versatility, making it a valuable feature for creating customized lighting environments in the room.

In some embodiments, a first variation rate of the driving currents supplied to the first type LED modules is the same as a second variation rate of the driving currents to the second type LED modules.

In certain embodiments of a lighting system, there are two types of LED modules: the first type and the second type. These LED modules are driven by a driver circuit, which controls the current supplied to them for illumination.

Now, the statement mentions that the “first variation rate” of the driving currents supplied to the first type LED modules is the same as the “second variation rate” of the driving currents supplied to the second type LED modules. This means that any change or adjustment made to the driving current of the first type LED modules will be mirrored exactly in the driving current of the second type LED modules.

In an example, the current supplied to the first type LED modules is initially set at 100 mA (milliamperes). Now, if there's a need to increase the brightness of the first type LED modules by 10%, the driver circuit will make a proportional adjustment. In this case, a 10% increase in the current is added, making it 110 mA for the first type LED modules.

Now, the crucial point is that the “second variation rate” is identical. So, when the driving current to the first type LED modules is increased by 10%, the same 10% increase is simultaneously applied to the second type LED modules. This means the initial current supplied to the second type LED modules (let's say 90 mA) will also increase by 10% to become 99 mA.

In essence, the driver circuit ensures that any changes or adjustments made to the driving current of one type of LED module are precisely mirrored in the other type. This synchronized adjustment in driving currents ensures that both types of LED modules maintain consistent relative brightness levels, ensuring uniformity in the lighting system.

In some embodiments, the first type LED modules and the second type LED modules are disposed on a single power path for receiving the driving currents.

In certain embodiments of an LED lighting system, the configuration involves two distinct types of LED modules: the first type and the second type. These LED modules are integral to the system's operation and require a controlled supply of electrical current for illumination. In these embodiments, a specific arrangement is employed to efficiently deliver the driving currents to both types of LED modules.

Within this design, the first type LED modules and the second type LED modules are strategically positioned along a single power path. This power path serves as the conduit through which the driving currents are supplied to all the LED modules in the system. In other words, it's the common route by which electrical power flows to energize the LEDs.

To illustrate this arrangement further, consider a scenario in which all the first type LED modules and the second type LED modules are connected in series. This means that they are physically linked in a sequential manner, forming a continuous chain. As a result, they share the same current path. When an electrical current is applied at one end of this series-connected chain, it flows through each LED module, illuminating them in succession.

This series connection has several advantages. Firstly, it simplifies the electrical circuitry by reducing the need for complex branching or separate current paths. Secondly, it ensures that the driving currents are distributed uniformly among all the LED modules in the series. Each LED module receives a portion of the total current, allowing for consistent and balanced illumination.

Moreover, this arrangement facilitates efficient current regulation, as the driver circuit can monitor and adjust the current in the shared power path to meet the specific requirements of both the first type and the second type LED modules. It ensures that the LEDs operate within their specified current limits, optimizing their performance and longevity.

In summary, in these embodiments, the first type LED modules and the second type LED modules are interconnected along a single power path, often in a series connection. This configuration streamlines the electrical distribution and regulation of driving currents, promoting uniformity in illumination and enhancing the overall efficiency of the LED lighting system.

In some embodiments, the lighting apparatus may also include a light source plate.

The first type of LED modules and the second type of LED modules are arranged on multiple concentric circles of the light source plate.

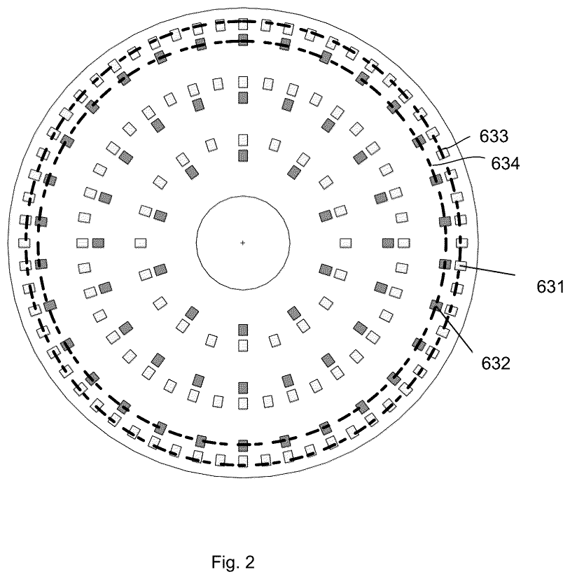

FIG. 2 shows a light source plate mounted with first type LED modules 631 and second type LED modules 632. In FIG. 2, the first type LED modules and second type LED modules are marked with different gray colors.

In some embodiments, a first concentric circle 633 is used for disposed the first type LED modules 631.

A second concentric circle 634 is used for disposing the second type LED modules 634.

In the example of FIG. 2, there are several concentric circles alternatively disposing the first type LED modules 631 and the second type LED modules 632.

In a circular sector covering a portion of the first concentric circle and a portion of the second concentric circle, a first number of the first type LED modules is a multiple of a second number of the second type LED modules.

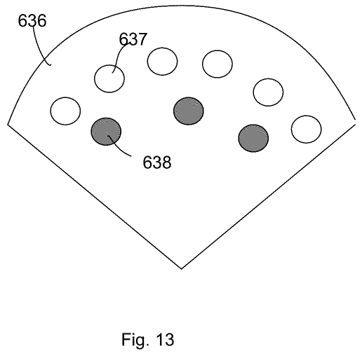

Please see FIG. 13, which illustrates a circular sector 636 that illustrates an extended example of the example of FIG. 2.

In FIG. 13, the circular sector 636 of the light source plate is mounted with first type LED modules 637 and the second type LED modules 638. In the example of FIG. 13, the quantity of the first type LED modules 637 is two times of the second type LED modules 638.

In some embodiments, a quality of the second type LED modules are determined after the first color temperature and the third color temperature are determined.

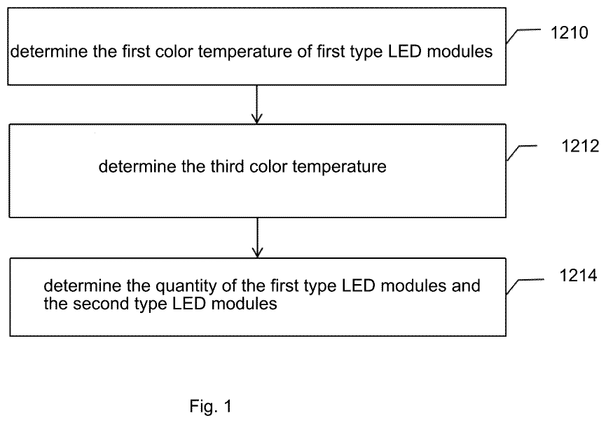

FIG. 1 illustrates a flowchart for determining the method. In FIG. 1, determine a first color temperature of the first type LED module (step 1210).

Then, the third color temperature of the final output of the lighting apparatus is determined (step 1212).

Next, the quantity ratio between the first type LED modules and the second type LED modules is determined (step 1214).

In some embodiments, the driver circuit adjusts a current ratio between the driving currents supplied to the first type LED modules and the second type LED modules to change the third color temperature.

In previous examples, the second type LED modules are either turned off completely or turned on 100%. In some other embodiments, when the current ratio between the second type LED modules and the first type LED modules may be further adjusted to meet certain requirements, i.e. the third color temperatures may be further adjusted.

In some embodiments, the driver circuit has a night light mode.

In the night light mode, only the second type LED modules are turned on.

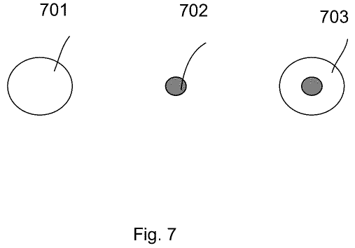

In FIG. 7, the first type LED modules have a first spreading light angle 701 and the second type LED modules have a second spreading light angle 702.

The first light spreading angle 701 is different from the second light spreading angle 702.

In some embodiments, the first type LED modules and the second type LED modules use different types of lenses to achieve different light spreading angles.

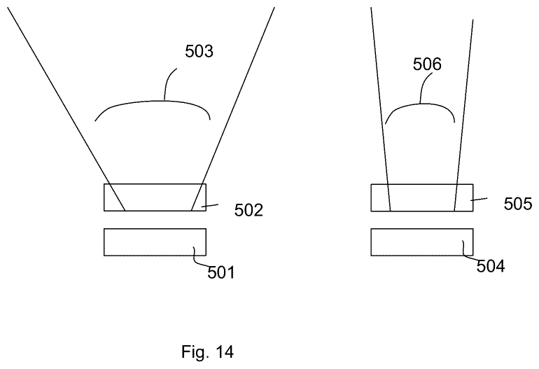

FIG. 14 shows a first type LED module that has a first LED chip 501 and a first lens 502, and a second type LED module that has a second LED chip 504 and a second lens 505. The spreading angles 503 and 506 are different because of the lenses 502, 505 in this example. In such case, the first LED chip 501 and the second LED chip 504 may even be the same. In some other embodiments, the first LED chip 501 and the second LED chip 504 may be different.

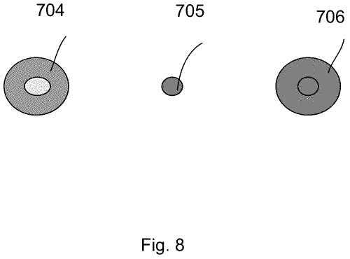

FIG. 8 shows another light spreading patterns that provide further control on the first type LED modules and the second type LED modules.

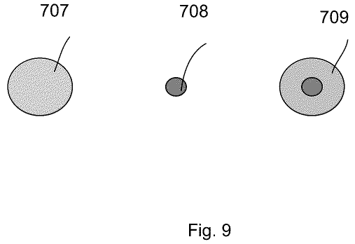

As mentioned above, lens may be used for changing lights. The light spreading patterns in FIG. 7, FIG. 8 and FIG. 9 show overall light patterns mixed by the first type LED modules and the second type LED modules.

In the example of FIG. 8, the lenses are used for leaving the middle part sparse while the peripheral area more condense for the light of the first type LED modules. The central part is mainly reserved for the second type LED modules.

In some other example, the first type LED modules may focus on the middle focus area while the second type LED modules focus on the exterior peripheral area.

FIG. 9 shows a different example. In FIG. 9, the light intensity ratio between the first type LED modules and the second type LED modules is adjusted to change the contrast between the two areas.

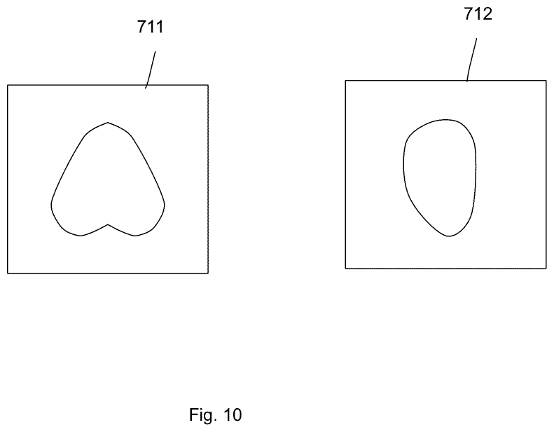

FIG. 10 shows two light distribution diagrams 711, 712 that are commonly known in the field to show light intensity distributions on different positions and directions.

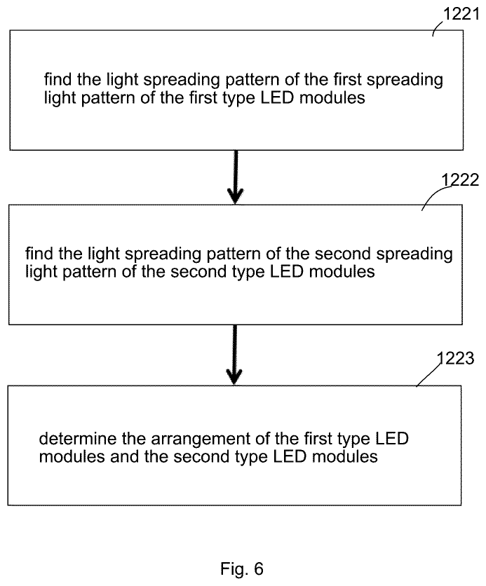

FIG. 6 shows a flowchart for a design steps.

In FIG. 6, the light spreading pattern of the first type LED modules is determined (step 1221). Then, the light spreading pattern of the second type LED modules is determined (step 1222).

Based on the data acquired, the first type LED modules and the second type LED modules are arranged to achieve different light patterns needed.

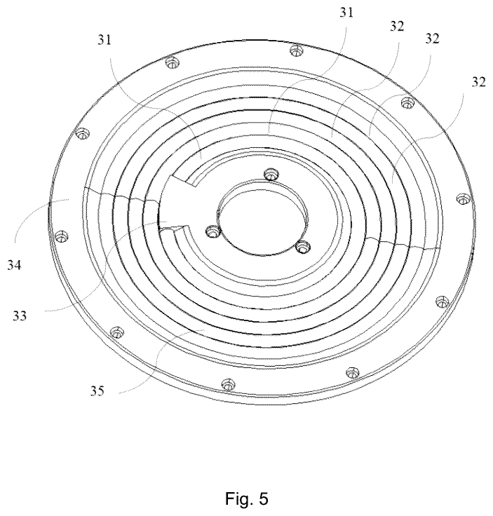

Please refer to FIG. 5, which illustrates a lens module. The lens module has multiple concentric concave-convex structures forming concentric lenses 32, 32, 33, 35 surrounding by an peripheral edge 34.

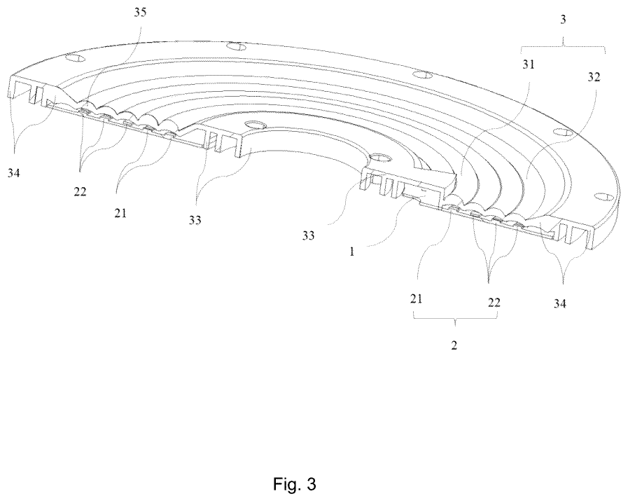

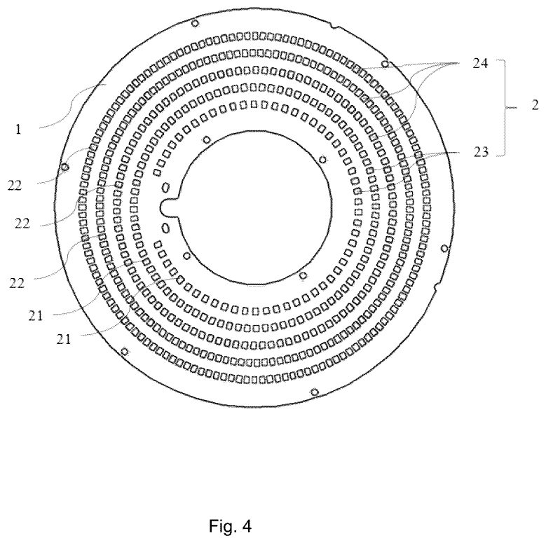

Please also refer to FIG. 3 and FIG. 4, which shows a light source plate 1 mounted with second type LED modules 21 and first type LED modules 22 that together form a light source 2. The concave-convex structures 32, 32 form the lens 3. There is a central part 33 forming a central hole.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a plurality of first type LED modules, wherein the first type LED modules emits a first light of a first color temperature;
a plurality of second type LED modules, wherein the second type LED modules emits a second light of a second color temperature, wherein the first color temperature is different from the second color temperature; and
a driver circuit for converting an external power to generate multiple driving currents to the first type of LED modules and the second type of LED modules, wherein the driver circuit provides a first working mode and a second working mode, wherein in the first working mode, the second type LED modules are disabled so that only the first type LED modules are turned on to emit a first output light of the first color temperature, wherein in the second working mode, the first type LED modules and the second type LED modules are both turned on to generate a second output light of a third color temperature.

2. The lighting apparatus of claim 1, wherein an intensity offset between the first output light of each first type LED module and the second output light of each second type LED module is less than 10% of a first light intensity of the first output light of the first type LED module.

3. The lighting apparatus of claim 2, wherein a first total driving current supplied to the first type LED modules in the first working mode is larger a second total driving current supplied to the second type LED modules in the second working mode.

4. The lighting apparatus of claim 1, further comprising a manual switch coupled to the driver circuit for a user to select the first working mode or the second working mode.

5. The lighting apparatus of claim 4, further comprising a light housing, wherein the manual switch is disposed on an external surface of the light housing, and the first type LED modules and the second type LED modules are disposed inside the light housing.

6. The lighting apparatus of claim 5, wherein the driver circuit keeps either the first working mode or the second working mode unless the user operates the manual switch to change a working mode from the first working mode to the second working mode or from the second working mode to the first working mode.

7. The lighting apparatus of claim 6, wherein a label aside the manual switch indicates only the first color temperature and the third color temperature, wherein the second type LED modules are not turned on if the first type LED modules are not turned on.

8. The lighting apparatus of claim 1, wherein there is a first offset between the first color temperature and the third color temperature, wherein there is a second offset between the second color temperature and the third color temperature, wherein the first offset if smaller than the second offset.

9. The lighting apparatus of claim 8, wherein a difference between the first color temperature and the third color temperature is more than 20% of the second offset.

10. The lighting apparatus of claim 9, wherein the difference between the first color temperature and the third color temperature is larger than 50% of the second offset.

11. The lighting apparatus of claim 1, wherein a level switch is coupled to the driver circuit for a user to adjust a first light intensity of the first output light and a second light intensity of the second output light.

12. The lighting apparatus of claim 11, wherein a first variation rate of the driving currents supplied to the first type LED modules is the same as a second variation rate of the driving currents to the second type LED modules.

13. The lighting apparatus of claim 12, wherein the first type LED modules and the second type LED modules are disposed on a single power path for receiving the driving currents.

14. The lighting apparatus of claim 1, further comprising a light source plate, wherein the first type of LED modules and the second type of LED modules are arranged on multiple concentric circles of the light source plate.

15. The lighting apparatus of claim 14, wherein a first concentric circle is used for disposed the first type LED modules, wherein a second concentric circle is used for disposing the second type LED modules, wherein in a circular sector covering a portion of the first concentric circle and a portion of the second concentric circle, a first number of the first type LED modules is a multiple of a second number of the second type LED modules.

16. The lighting apparatus of claim 1, wherein a quality of the second type LED modules are determined after the first color temperature and the third color temperature are determined.

17. The lighting apparatus of claim 1, wherein the driver circuit adjusts a current ratio between the driving currents supplied to the first type LED modules and the second type LED modules to change the third color temperature.

18. The lighting apparatus of claim 1, wherein the driver circuit has a night light mode, wherein in the night light mode, only the second type LED modules are turned on.

19. The lighting apparatus of claim 1, wherein the first type LED modules have a first spreading light angle and the second type LED modules have a second spreading light angle, wherein the first light spreading angle is different from the second light spreading angle.

20. The lighting apparatus of claim 19, wherein the first type LED modules and the second type LED modules use different types of lenses to achieve different light spreading angles.
